(19) United States
(12) Patent Application Publication
(10) Pub. No.: US 2021/0372703 A1
(43) Pub. Date: Dec. 2, 2021

(54) METHOD FOR DETERMINING FUGITIVE EMISSION FACTOR (EF) AND LEAKAGE RATE OF COMBUSTION SOURCE

(71) Applicant: Peking University, Beijing (CN)

(72) Inventors: Guofeng Shen, Beijing (CN); Shu Tao, Beijing (CN); Wei Du, Beijing (CN); Yuanchen Chen, Beijing (CN)

(73) Assignee: Peking University, Beijing (CN)

(21) Appl. No.: 17/038,658

(22) Filed: Sep. 30, 2020

(30) Foreign Application Priority Data
May 28, 2020 (CN) 202010466883.0

(51) Int. Cl. F27D 21/00; F27D 19/00

(52) U.S. Cl. CPC F27D 21/00; F27D 2021/0057; F27D 2019/0015; F27D 19/00

(57) ABSTRACT

A method for determining a fugitive emission factor (EF) and a leakage rate of a combustion source. For a combustion source capable of performing stack emission and fugitive emission, an organized EF, a fugitive EF, and a leakage rate of fugitive emission are respectively obtained through calculation based on material balance. The method solves the problem that it is impossible to collect a total amount of smoke and to quantify its volume in a field test and the problem that a conventional carbon mass balance (CMB) method cannot distinguish organized leakage from fugitive leakage. The method can be used not only for determining gas leaked from residential indoor stoves using coal, biomass, etc., but also for determining fugitive emissions from other sources, such as the amount of gas leaked to the surrounding environment through the body of a brick kiln in a brick and tile factory.

### TECHNICAL FIELD

The present invention belongs to the field of air pollution research and particularly relates to a method for determining a pollutant emission factor (EF). In the method, EFs for a combustion source including stack and fugitive emissions and a leakage rate of fugitive emissions are obtained through calculations based on a newly developed carbon mass balance approach.

### BACKGROUND

Air pollution is a global environmental problem. International Agency fOr Research on Cancer (IARC) has identified air pollution as a “carcinogen.” Straif, Cohen & Samet, Air Pollution and Cancer, International Agency for Research on Cancer, IARC Scientific Publication 161, ISBN 978-92-832-2166-1. According to the study of the Global Burden of Cancer, about 4.9 million people die prematurely every year due to exposure to air pollution. Among them, about 2.94 million people die prematurely due to outdoor fine particulate matter (PM_{2.5}), and about 1.64 million people die prematurely due to exposure to indoor pollution associated with the use of solid fuels, such as biomass and coals. Global Burden of Disease, Institute for Health Metrics and Evaluation (IHME), www.healthdafa.org/data-visualization/gbd-compare; Burnett et al., Global Estimates of Mortality Associated with Long-Term Exposure to Outdoor Fine Particulate Matter, PNAS 2018, 115, 9592-9597.

Incomplete combustion of solid fuel is an important source of atmospheric pollutants such as PM_{2.5} and CO. Power plants, industrial combustion sources, residential combustion processes, etc. are important combustion sources of air pollution and precursor sources of secondary fine PM. Among these pollution combustion sources, the residential source has a great contribution to outdoor air pollution, especially heavy pollution in winter, because of its low combustion efficiency and lack of terminal control and other mitigation technologies. Liu et al., Air Pollutant Emission for Chinese Households: A Major and Underappreciated Ambient Pollution Source, PNAS 2016, 113, 7756-7761; Shen et al., Impacts of Air Pollutants from Rural Chinese Households Under the Rapid Residential Energy Transition, Nature Communication 2019, 10. Combustion of household fuels occurs mostly indoors, which additionally causes serious indoor pollution. Most people spend more than 80% of their time indoors, so serious indoor pollution causes high exposure to air pollution and health hazards.

An EF of a pollutant from a combustion source (defined as the mass of pollutants emitted by fuel combustion per unit mass or per unit energy) can be measured by simulation experiments in a laboratory, and can also be tested in the actual environment. The concentration of pollutants and the volume of all exhaust gases (total amount collected) are measured or calculated in laboratory measurements to obtain the EFs. Studies have confirmed that there may be great differences between emission characteristics of pollutants obtained under laboratory experiments and those obtained under field conditions. This leads to the deviation and high uncertainty of an EF and other data. Du et al., Household Air Pollution and Personal Exposure to Air Pollutants in Rural China—A Review, Environ. Pollut. 2018, 27, 625-638. In field measurements, it is difficult to collect the total amount of exhaust gas, so a method based on carbon mass balance (CMB) was developed to calculate the EF of a pollutant. The basic assumption of the CMB method is that C released from the fuel combusted mainly exists as gaseous CO₂, CO, methane and non-methane hydrocarbons, as well as PM. It is assumed that pollutants in exhaust gases are mixed evenly, the concentration obtained by sampling at a certain point represents the average concentration in the exhaust gas, and the pollutant EF can be calculated by the CO₂ EF. The advantage of the CMB method is that the total EF can be obtained without the need to collect the total amount of exhaust gas. As a mature method, CMB is widely used in the study of the field test of emissions of indoor combustion sources. For example, the EF of straw burning in open air can be calculated by the CMB method. Laboratory test results can also be calculated with reference to the CMB method for mutual verification.

However, in the actual combustion process, pollutants generated by indoor combustion sources are released into the outdoor atmosphere in the form of stack emission through chimneys, but a considerable amount of combustion products are directly released into the room (indoor air). That is, fugitive indoor leakage occurs, thus polluting the indoor environment. The indoor leakage emission of pollutants generated by fuel in combustion devices such as indoor stoves is an important source of indoor air pollution. However, this key process has always lacked effective quantitative description. In the process of formulating Indoor Air Quality Guidelines, the World Health Organization (WHO) could only indirectly estimate the leakage rate of CO and PM_{2.5} to be about 25% by comparing the difference between the indoor concentration in households with chimneys and the indoor concentration in households without chimneys. This estimation was used because there is no basic data on indoor leakage EF and leakage rate (the percentage of the fugitive EF in the total EF). Johnson et al., Review 3: Model for Linking Household Energy Use with Indoor Air Quality, WHO Indoor Air Quality Guideline: Household Fuel Combustion, www.who.int/airpollution/guidelines/household-fuel-combustion.

To obtain the leakage EF and leakage rate, research teams of the US Environmental Protection Agency (EPA) and the National University of Mexico used smoke-capture hoods in laboratories to measure emissions from the stack and fugitive processes. The leakage EFs and leakage rates of CO and PM₂ were then calculated according to the measured pollutant concentration and the volume of the total amount of smoke collected. Ruiz-Garcia et al., Fugitive Emission and Health Implications of Plancha-type Stoves, Environ. Sci. Technol. 2018, 57, 10848-10855; Jetter, Test Report—In Stove 60-Liter Institutional Stove with Wood Fuel—Air Pollutant Emission and Fuel Efficiency, US Environmental Protection Agency, Washington, D.C., EPA/625/R-16/003, 2016. However, the experimental results show that the leakage FE is very small, and the leakage rate of pollutants was less than 5%, which was quite different from the value adopted in the WHO guidelines. Therefore, in order to obtain more accurate basic data such as the total pollutant EF, the fugitive leakage EF, and the leakage rate, it is necessary to obtain data in a real-world setting.

As mentioned above, the gas-capture hood used in laboratory testing to collect pollutants leaked from stoves is large in size and inconvenient to carry and implement in a field measurement. A kitchen has a narrow space while the gas-capture hood and pipeline occupy a large space, making it inconvenient to place the gas-capture hood and the pipeline. In addition, there is no restriction on installation and erection conditions in the field. Therefore, a device for collecting combustion source exhaust gas in the laboratory and a method for calculation (the smoke concentration and the volume of the total amount of gas collected) cannot be effectively used in the field. With respect to the conventional CMB method, the assumption that the exhaust gas is uniformly mixed has certain deviation, so only the total EF can be obtained, and the organized EF and the fugitive EF cannot be separately calculated. As a result, the leakage rate cannot be obtained.

### SUMMARY

In view of the problems that an organized EF and a fugitive EF of a combustion source cannot be obtained by a conventional CMB method, the present invention provides a calculation method that can obtain the fugitive EF and a leakage rate without the use of a gas-capture hood to collect emission exhaust.

Taking a stove with a chimney as an example, leakage emission (fugitive emission) and chimney emission (stack emission) of the stove are regarded as two different emission paths. The total emission of the stove is composed of the leakage emission and the chimney emission. The two emissions are obtained by calculating the pollutant concentration and the gas volume respectively:

EF_{total,x}=EF_{fugitive,x}+EF_{chimney,x}=(C_{fugitive,x}·V_{fugitive}+C_{chimney,x}·V_{chimney})/M_{fuel}

where EFₜₒₜₐₗ, EF_{fugitive,x} and denote a total EF, a leakage EF and a chimney EF of an air pollutant x (g/kg) respectively, and C_{fugitive,x} and C_{chimney,x} denote mass concentrations (g/L) of the pollutant x from leakage emission and the pollutant x from chimney emission respectively, V_{fugitive} and V_{chimney} denote volumes (L) of leaked gas and gas emitted through the chimney respectively, and M_{fuel} is the mass (kg) of fuel burned.

Concentrations (C_{chimney,x} and C_{fugitive,x}) of pollutants from chimney emission and leakage emission are obtained by direct measurement, and the volume (V_{chimney}) of exhaust gas emitted through the chimney can be calculated according to the measured chimney exhaust flow and sampling (or combustion) duration. However, under field conditions, it is difficult to measure the volume (V_{fugitive}) of exhaust gas from leakage emission. In laboratory research, V_{fugitive} is usually obtained by completely capturing leaked emission by using a gas-capture hood.

Based on CMB, total carbon emission can be regarded as the sum of chimney emission and leakage emission. The mass of C in chimney and leakage emission can be calculated according to the concentration and gas volume of carbon based species including carbon dioxide (CO₂), carbon monoxide (CO), total hydrocarbons (THC) and particulate carbon:

M_{c-fuel}−M_{c-ash}=M_{c-chimney}+M_{c-fugitive}=C_{c-species,chimney}·V_{chimney}+C_{c-species,fugitive}·V_{fugitive}

where M_{c-fuel}, M_{c-ash}, M_{c-chimney} and M_{C-fugitive} denote the mass (g) of C in fuel, remaining ash, chimney emission and leakage emission respectively, and C_{c-species, chimney} and C_{c-species, fugitive} denote mass concentrations of carbon-based species from chimney emission and leakage emission respectively.

Therefore, when the total carbon emission can be obtained, the calculation formula of V_{fugitive} is as follows:

V_{fugitive}=(M_{c-fuel}−M_{c-ash}−C_{c-species,chimney}·V_{chimney})/C_{c-species,fugitive}.

In this method, it is important to measure the chimney gas flow (or velocity).

Based on the foregoing principle, the present invention provides a method for determining a fugitive EF and leakage rate of a combustion source, including the following steps:

### 1. Emission Test

This process includes: weighing a certain amount of fuel for a combustion test, monitoring concentrations of pollutants including concentrations of various carbon-based species in the smoke at a stack emission port and a leakage position (such as a fuel adding position), measuring the cross-sectional area of the stack emission port and measuring the smoke flow velocity in the chimney during the combustion process: after the combustion ends, recording emission time, weighing the mass of remaining fuel, and collecting all ash.

Taking stack emission through a chimney as an example, the process may specifically include the following steps.

(1) Preparation for a combustion experiment: the mass of fuel is weighed and some samples are taken to analyze fuel properties (carbon content, etc.).

(2) Measurement of the gas concentration/collection of PM: the emission concentration of smoke is measured by two similar emission measuring devices. Sampling probes are placed near a chimney outlet and a main leakage port (such as a fuel adding position) of a stove respectively. According to a difference between concentrations of pollutants at the two positions and a measuring range of the instruments, an air dilution ratio is adjusted, and gas and particle concentrations are measured by on-line and/or off-line instruments. Additionally, the flow rate of each pump and sampling time in the sampling process in real time are recorded to calculate a dilution ratio of chimney emission and a sampling volume. Before each test, a gas sensor is subjected to zero-point and span calibration in the laboratory, and the gas sensor in the field is subjected to Mill testing. The background concentration of pollutants is measured for at least fifteen minutes before and after the field test.

(3) Measurement of the stack emission gas flow velocity at a chimney opening: a real-time flow velocity of smoke is measured by an anemometer specially designed for measuring high-temperature gas. The anemometer is calibrated before use. An anemometer inlet is placed near a chimney outlet at the same position as an emission-sampling probe.

(4) The emission test covers the whole combustion process. Remaining fuel is weighed. All ash is collected and weighed, and some samples are reserved for the measurement of the carbon content.

### 2. Sample Analysis

The water content of the fuel, the carbon content of the fuel, the carbon content of the ash, and the average concentration of various carbon-based species and pollutants at the stack emission port and the leakage position during the emission period are measured. This process specifically includes:

(1) drying fuel and weighing the fuel before and after drying, and measuring the water content of the fuel; after the collected ash is dried, weighing the ash to obtain the dry weight Mₐₛₕ of the ash;

(2) analyzing elements of the dried, fuel and the ash, and measuring their carbon contents C% respectively;

(3) calculating the mass of PM according to weight changes of a sampling membrane before and after sampling; and

(4) handling instrument data measured to obtain the average concentration of various carbon-based species and pollutants during the emission test.

### 3. Data Processing and Analysis

(1) The dry weight M_{fuel} of fuel used for combustion is calculated according to the measured water content of the fuel.

(2) The total mass Qₑₘᵢₛₛᵢₒₙ of carbon emission is calculated by Qₑₘᵢₛₛᵢₒₙ=Q_{fuel}−Qₐₛₕ=M_{fuel}×C_{%,fuel}−Mₐₛₕ×C_{%,ash}, where Q_{fuel} and Qₐₛₕ are masses of carbon in the combustion fuel and ash respectively, and C_{%,fuel} and C_{%,ash} are measured carbon contents (on a dry basis, measured by experiments) of the fuel and the ash respectively.

(3) The mass Q_{chimney} of carbon from organized (chimney) emission is calculated by Q_{chimney}=C_{C-species-C,chimney}×V_{chimney}=(C_{CO2-C}+C_{CO-C}+C_{CH4-C}+C_{PM-C})_{chimney}×V_{chimney}, where V_{chimney} is the volume of organized smoke emission and is calculated by multiplying the cross-sectional area S_{chimney} with a stack emission port by the smoke flow velocity v and emission time t, V_{chimney}=S_{chimney}×v×t. C_{C-species-C, chimney} is the mass concentration of total carbon in organized smoke emission and is the sum of mass concentrations of carbon in various carbon-containing substances in smoke; and C_{CO2-C}, C_{CO-C}, C_{CH4-C} and C_{PM-C} are mass concentrations (g/L) of carbon in four carbon-based species: CO₂, CO, CH₄ and PM respectively. However, the carbon-based species are not limited to these four. In an actual test, the mass concentration (C_{C-species,chimney}) of carbon-based species is directly measured, so the mass concentration needs to be converted into the mass concentration (C_{C-species-C, chimney}) of carbon in carbon-based species. The conversion formula is as follows:

C_{C-species-C}=C_{C-species}×MWc/V

where C_{C-species-C} is the mass concentration of carbon in a carbon-based species, is the mass concentration of a carbon-based species, MWc is the molar mass of carbon (12 g/mol), and V is the molar volume of gas (22.4 L/mol under standard conditions).

(4) The mass Q_{fugitive} of fugitive (leakage) carbon emission is calculated by Q_{fugitive}=Qₑₘᵢₛₛᵢₒₙ−Q_{chimney}. The leaked carbon is equal to the total carbon emission minus the organized carbon emission.

(5) The equivalent volume V_{fugitive} of fugitive smoke emission (leakage) is calculated by V_{fugitive}=Q_{fugitive}/C_{C-species-C,fugitive}=Q_{fugitive}/(C_{CO2-C}+C_{CO-C}+C_{CH4-C}+C_{PM-C})_{fugitive}, where C_{C-species-C, fugitive} is the mass concentration of total carbon in fugitive smoke emission. The carbon mainly exists in carbon-based species CO₂, CO, CH₄ and PM in smoke, and C_{CO2-C}, C_{CO}, C_{CH4-C} and C_{PM-C} denote the mass concentrations (g/L) of carbon in CO₂, CO, CH₄ and PM respectively.

(6) An organized EF and a fugitive EF are calculated. An organized EF (EF_{chimney, x}) of any pollutant x is calculated by EF_{chimney, x}=V_{chimney}×C_{chimney,x}/M_{fuel}. A fugitive EF (EF_{fugitive, x}) of any pollutant x is calculated by EF_{fugitive, x}=V_{fugitive}×C_{fugitive,x}/M_{fuel}. C_{chimney,x} and C_{fugitive,x} are the mass concentrations of any pollutant x from stack emission and fugitive emission respectively.

(7) A leakage rate is calculated. A proportion F of the amount of any pollutant x leaking indoors in the total emission is calculated by F=EF_{fugitive,x}/(EF_{fugitive,x}+EF_{chimney,x}).

The present invention relates to a novel calculation method, which can obtain a fugitive leakage EF and a leakage rate. The method solves the problem that it is impossible to collect a total amount of smoke and quantify its volume in field test and the problem that a conventional CMB method cannot distinguish organized leakage from fugitive leakage. This method can be used not only for the quantification (a leakage EF and a leakage rate) of gas leaked from residential indoor stoves using coal, biomass, etc., hut also for the determining fugitive emission from other sources. For example, the amount of gas leaked to the surrounding environment through the body of a brick kiln in a brick and tile factory, except the stack emission of chimneys, can be calculated.

### DETAILED DESCRIPTION

The present invention provides a method for measuring leakage emission of pollutants from solid fuel combustion in an indoor stove, which will be described in detail by taking a leakage emission test of stoves with chimneys in a rural area of Nanchong, Sichuan Province in July 2019 as an example. The method included the following steps.

### 1. Emission Test

(1) About 1.5 kg of each of biomass fuels (firewood, straw, bamboo, etc.) used by local farmers daily was weighed, and local farmers were asked to burn the biomass fuels in the stoves with chimneys, in this case, branches were used as an example.

(2) Measurement of the gas concentration/collection of PM: emission was collected by two similar emission measuring devices. Sampling probes were placed near a chimney outlet and a fuel feeding position close to a stove. According to the concentrations of pollutants at the two positions and the measurement range of an instrument, the emission was diluted with clean air, and the target pollutants such as CO/CO₂/CH₄ and NO/NO₂/SO₂ were measured online. PM_{2.5} was collected using filters. The flow rate of each pump in the sampling process was recorded in real time to calculate a dilution ratio of chimney emission. The sampling time was recorded to calculate the sampling volume. This particular sampling duration was 21.2 minutes in total. Before each test, a gas sensor was subjected to zero-point and span calibration in the laboratory and the gas sensor in the field was subjected to null testing. Background concentration of pollutants was measured and the average value was subtracted from the combustion emission calculation.

(3) Measurement of the exhaust gas velocity at a chimney opening: real-time velocity of the smoke was measured by an anemometer specially designed for measuring high-temperature gas. The gas velocity was calculated by the anemometer by using a constant temperature method, and the gas velocity, temperature, and relative humidity were recorded automatically. Before on-site use, the anemometer was calibrated by a standard turbine flowmeter. An anemometer inlet was placed near a chimney outlet at the same position as an emission-sampling probe. The emission sampling covers the whole combustion process. The cross-sectional area S_{chimney} of the chimney was 0.0241 m². The smoke flow velocity v at the chimney opening was 1.61 m/s. Therefore, the volume of smoke from chimney emission is V_{chimney}=S_{chimney}×v×t=0.0241 m²×1.61 m/s×21.2×60=49.39 m³=49,390 L.

(4) Remaining fuel was weighed, and all ash was collected.

### 2. Sample Analysis

(1) The fuel was dried by an oven, and the water content of the fuel was measured to be 9.5%; all the collected ash was dried by the oven, and the dry weight Mₐₛₕ of the ash was measured to be 140 g by an electronic balance.

(2) Elements of the fuel and the ash were analyzed, The carbon content of fuel on a dry basis was measured to be 45.1%. The carbon content of ash on a dry basis was 73.5%.

(3) A sampling membrane was weighed before and after sampling, and the difference was the mass of collected PM.

(4) An instrument directly measured concentrations of CO₂, CO, and CH₄ during the emission test period. The average concentration (C_{C-species}) (it should be noted that the unit in measurement by the instrument was generally ppm, so it needed to be divided by 10⁶ to be expressed as the result of g/L) was measured during the whole sampling period. The mass concentrations C_{CO2-C}, C_{CO-C} and C_{CH4-C} of carbon in these carbon-based species were further calculated. The carbon content C_{PM-C} in PM was measured by using a photothermal method (such as an OC/EC analysis meter).

The total carbon mass concentrations C_{C-species-C, chimney} and C_{C-species-C, fugitive} in organized (chimney) emission and fugitive (leakage) emission were obtained by summing the measured concentrations of carbon-based species in chimney smoke and leakage smoke, respectively.

Since the mass concentration of carbon in PM is much lower than that of other pollutants, C_{PM-C} can be ignored. In this measurement, the concentrations of CO₂, CO, and CH₄ were 6.39×10³ g/L, 2.15×10⁻⁴ g/L, and 4.30×10⁻⁴ g/L, respectively. MWc was 12 g/mol, and the molar volume of gas was 22.4 L/mol. Therefore,

$$\begin{matrix}{C}_{C \text{-} species \text{-} C , chimney} = ( {C}_{CO 2} + {C}_{CO} + {C}_{CO 4} + {C}_{PM} ) chimney \times MWc / V \\ = \begin{matrix}( {C}_{CO 2} + {C}_{CO} + {C}_{CH 4} ) chimney \times \\ 12 g \text{/} mol / 22.4 L \text{/} mol\end{matrix} \\ = \begin{matrix}( 6.39 \times {10}^{\text{-} 3} + 2.15 \times {10}^{\text{-} 4} + \\ 4.30 \times {10}^{\text{-} 4} ) \times 12 g \text{/} mol / 22.4 L \text{/} mol\end{matrix} \\ = 3.77 \times {10}^{\text{-} 3} g \text{/} L\end{matrix}$$

The results show that 0.00377 g of carbon was contained in each her of gas emitted through the chimney.

In the same way, the concentrations of CO₂, CO, and CH₄ measured by the instrument were 2380 ppm, 68.7 ppm, and 25.9 ppm respectively; namely 2.38×10⁻³ g/L, 6.87×10⁻⁵ g/L, and 2.59×10⁻⁵ g/L.

C_{C-species-C,fugitive}=(2.38×10⁻³+6.87×10⁻⁵+2.59×10⁻⁵)×12 g/mol/22.4 L/mol=0.00133 g/L

On average, 0.00133 g carbon was contained in each liter of leaked smoke.

3. Calculation of a Leakage EF and a Leakage Rate

(1) The dry weight M_{fuel} of fuel was calculated according to the water content: the dry weight of fuel was 1.15 kg×(1-9.5%)=1.04 kg according to the mass of burned fuel, which was 1.15 kg.

(2) Calculation of the total mass of carbon emission:

Qₑₘᵢₛₛᵢₒₙ=Q_{fuel}−Qₐₛₕ=M_{fuel}×C_{%,fuel}−Mₐₛₕ×C_{%,ash}=1040 g×45.1%−140 g×73.5%=366 g.

(3) Calculation of the mass of carbon in chimney emission:

Q_{chimney}=3.77×10⁻³ g/L×49390 L=186 g.

(4) Calculation of the mass of carbon in leakage emission:

Q_{fugitive}=Qₑₘᵢₛₛᵢₒₙ−Q_{chimney}=366 g−186 g=180 g.

The leaked carbon was equal to the total carbon emission minus the carbon emission through the chimney opening.

(5) Calculation of the equivalent volume of leaked smoke:

V_{fugitive}=Q_{fugitive}/C_{C-species-C,fugitive}=180 g/0.00133 g/L=1.36×10⁵ L=136 m³.

(6) Calculation of an organized (chimney opening) EF of a pollutant x. The organized EF of any pollutant x emitted through the chimney opening, such as SO₂ (MW=64 g/mol), was calculated. The concentration of SO₂ from chimney emission measured by an instrument was 2.97 ppm and the molar volume of standard gas was 22.4 L/mol, then SO₂ in the chimney was converted into the mass concentration as follows: C_{chimney, SO2}=2.97 ppm/10⁶×64 g/mol/22.4 L/mol=8.49×10⁻⁶ g/L. According to the calculation in the previous step, the volume of gas from chimney emission was 49,390 L and the fuel consumption was 1.04 kg. Therefore, the organized (chimney) EF of SO₂ is: EF_{chimney, SO2}=C_{chimney,SO2}×V_{chimney}/M_{fuel}=8.49×10⁻⁶ g/L×49390 L/1.04 kg=0.40 g/kg.

(7) Calculation of a fugitive EF of a pollutant x. The concentration of SO₂ in the leaked smoke was measured to be 0.385 ppm, and was converted into the mass concentration as follows: C_{fugitive,SO2}=0.385 ppm/10⁶×64 g/mol/22.4 L/mol=1.10×10⁻⁶ g/L. According to the calculation in the previous step, the volume of leaked smoke was 135,900 L and the dry weight of fuel was 1.04 kg. The fugitive leakage EF of SO₂ is EF_{fugitive, SO2}=C_{fugitive,SO2}×V_{fugitive}/M_{fuel}=1.10×10⁻⁶ g/L×136000 L/1.04 kg=0.14 g/kg.

(8) Calculation of a leakage rate Fx of any pollutant x. The leakage rate was equal to the leakage EF divided by the total EF (a leakage EF+a chimney EF). For example, the calculation for SO₂ is: F_{SO2}=EF_{fugitive,SO2}/(EF_{fugitive,SO2}+EF_{chimney,SO2})=0.14/(0.14+0.40)×100%=26%.

1. A method for determining a fugitive emission factor (EF) and a leakage rate of a combustion source, comprising:
1) performing an emission test by weighing an amount of fuel for a combustion test; combusting the amount of fuel, monitoring concentrations of pollutants and concentrations of various carbon-based species in smoke at a stack emission port and a leakage position during the combustion process, measuring a cross-sectional area of the stack emission port and a smoke flow velocity in the combustion process; and, after the combustion ends, recording emission time, weighing the mass of remaining fuel, and collecting all ash;
2) measuring the dry weight of the ash, the water content of the fuel, the carbon content of the fuel, the carbon content of the ash, and the average concentration of carbon species and pollutants at the stack emission port and the leakage position during an emission period;
3)
(a) calculating the total mass Qₑₘᵢₛₛᵢₒₙ of carbon emission as
Qₑₘᵢₛₛᵢₒₙ=Q_{fuel}−Qₐₛₕ=M_{fuel}×C_{%,fuel}−Mₐₛₕ×C_{%,ash}
wherein Q_{fuel} and Qₐₛₕ are mass of carbon in the fuel used for combustion and the ash respectively, M_{fuel} and Mₐₛₕ are dry weights of the fuel used for combustion and the ash respectively C_{%,fuel} and C_{%,ash} are carbon contents of the fuel and the ash respectively, and the dry weight M_{fuel} of the fuel used for combustion is calculated according to the water content of the fuel;
(b) calculating the mass Q_{chimney} of organized carbon emission as
Q_{chimney}=C_{C-species-C,chimney}×V_{chimney}
wherein V_{chimney} is the volume of organized smoke emission and is calculated by multiplying the cross-sectional area S_{chimney} with a stack emission port by the smoke flow velocity v and emission time t; C_{C-species-C, chimney} is the mass concentration of total carbon in organized smoke emission;
(c) calculating the mass Q_{fugitive} of fugitive carbon emission as
Q_{fugitive}=Qₑₘᵢₛₛᵢₒₙ−Q_{chimney};
(d) calculating the equivalent volume V_{fugitive} of fugitive smoke emission as
V_{fugitive}=Q_{fugitive}/C_{C-species-C,fugitive}
wherein C_{C-species-C, fugitive} is the mass concentration of total carbon in fugitive smoke emission;
(e) calculating an organized EF and a fugitive EF as
EF_{chimney, x}=V_{chimney}×C_{chimney,x}/M_{fuel} and
EF_{fugitive, x}=V_{fugitive}×C_{fugitive,x}/M_{fuel}
wherein EF_{chimney, x} and EF_{fugitive, x} are the organized EF and the fugitive EF of any pollutant x respectively, and C_{chimney,x} and C_{fugitive,x} are mass concentrations of any pollutant x from stack emission and fugitive emission respectively; and
(f) calculating a leakage rate as
F=EF_{fugitive,x}/(EF_{fugitive,x}+EF_{chimney,x})
wherein F is a proportion of the leakage amount of any pollutant x in the total emission.

2. The method according to claim 1, wherein the mass concentration of carbon in the carbon-based species is obtained by conversion as
C_{C-species-C}=C_{C-species}×MWc/V;
wherein C_{C-species-C} is the mass concentration of carbon in a carbon-based species, C_{C-species} is the mass concentration of a carbon-based species, MWc is the molar mass of carbon and V is the molar volume of gas.

3. The method according to claim 2, wherein the main carbon-based species in smoke comprise CO₂, CO, CH₄, and particulate matter (PM).

4. The method according to claim 1, wherein the fuel is dried and the mass of the fuel is weighed before and after drying to measure the water content of the filet.

5. The method according to claim 4, wherein elements of the dried fuel and the ash are analyzed to measure the carbon content of the fuel on a dry basis and the carbon content of the ash on a dry basis.

6. The method according to claim 1, wherein in the velocity of smoke at a stack emission port is measured in real time by an anemometer specially designed for measuring high-temperature gas.

7. The method according to claim 1, wherein the leakage position is a fuel feeding position close to a fuel source,

8. The method according to claim 1, wherein the emission test covers the whole combustion process and the concentration of pollutants and the concentration of carbon-based species are recorded in real time, and further comprising processing the data to calculate average concentrations of pollutants and carbon-based species in the whole combustion process.
